(19) United States
(12) Patent Application Publication
(10) Pub. No.: US 2025/0105657 A1
(43) Pub. Date: Mar. 27, 2025

(54) ULTRA-LOW TEMPERATURE EMERGENCY STARTING POWER SUPPLY

(71) Applicant: GREPOW, Inc., Livermore, CA (US)

(72) Inventors: Bing Liu, Shenzhen (CN); Shiyu Liu, Shenzhen (CN); Bing Guo, Shenzhen (CN); Shixing Zhao, Shenzhen (CN)

(21) Appl. No.: 18/476,008

(22) Filed: Sep. 27, 2023

(51) Int. Cl. H02J 9/00; F02N 11/08; H02J 7/00; H02J 7/34; H02J 9/06

(52) U.S. Cl. CPC H02J 9/002; F02N 11/0866; F02N 11/087; H02J 7/0014; H02J 7/00308; H02J 7/0068; H02J 7/345; H02J 9/061; F02N 11/0837; F02N 2011/0874; F02N 2011/0885; H02J 2207/50

(57) ABSTRACT

A start-up power supply is provided that includes a battery, a supercapacitor module, and a switch module coupling an output of the supercapacitor module to an output connected to terminals of a vehicle battery. A charging circuit is coupled between the battery and the supercapacitor module and also to the output. A control module is coupled to the charging circuit, the switching module, the battery, and the supercapacitor module. The control module configured to first charge the supercapacitor module until the voltage of the supercapacitor module is higher than a pre-charge voltage of the supercapacitor module. Then to connect the battery and the supercapacitor module in parallel enabling the voltage of the supercapacitor module to charge to a voltage of the battery. Finally, to charge the supercapacitor module until the voltage of the supercapacitor module reaches a voltage of a full threshold of the supercapacitor module.

### TECHNICAL FIELD

The present invention pertains to the field of vehicular start-up power supplies and in particular to a start-up power supply that is capable of operating at very low temperatures.

### BACKGROUND

Lead-acid batteries commonly used to start vehicles do not have the ability to start the engine when undervoltage or when having no charge. At extremely low temperatures, a lead-acid battery of the vehicle cannot carry out the necessary chemical reactions, cannot supply power and will be unable to start the vehicle. When a vehicle cannot be started it prevents people's use of the vehicle, limits their ability to travel, and may lead to dangerous situations when people are stranded in low temperature conditions. To solve this problem, emergency start-up battery supplies, also known as start-up power supplies, have been developed by the industry. Presently, many different kinds of start-up power supplies exist on the market today. However, they have the disadvantage that they cannot start a vehicle immediately in extremely cold conditions, such as −40° C. or below.

The operating temperature of conventional emergency start-up battery supplies is typically only from −20 to 50° C., so that at lower temperatures, such as −40° C. or lower, the vehicle battery may not be boosted and the vehicle cannot be started.

To address this drawback, some emergency start-up battery supplies include a battery heating module. Although the working temperature of these devices may reach below −40° C., the internal system cannot provide enough power to heat the battery under this ambient temperature, so the entire heating process takes a prohibitively long time. The goal of starting the vehicle in a reasonably short time cannot be achieved.

Emergency start-up battery supplies may routinely use supercapacitors in order to be used in ultra-low temperature environments, such as at −40° C. or lower. However, when the lead-acid battery of a vehicle is dead or the power is very low, the supercapacitor cannot be charged quickly, which seriously affects the desired startup time.

Therefore, there is a need for an ultra-low temperature emergency start-up power supply solution, which can meet the requirements of quick start-up of vehicles in all weather conditions including under extremely cold conditions, such as −40° C., −55° C., or lower, that obviates or mitigates one or more limitations of the prior art.

This background information is provided to reveal information believed by the applicant to be of possible relevance to the present invention. No admission is necessarily intended, nor should be construed, that any of the preceding information constitutes prior art against the present invention.

### SUMMARY

An object of the present invention is to provide an ultra-low temperature emergency start-up power supply. Embodiments may achieve characteristics of high-power density, good low temperature performance, and high instantaneous discharge current of an included supercapacitor module to boost a vehicle battery and allow the vehicle to start. A built-in rechargeable battery enables the supercapacitor module to be charged and the vehicle to quickly be started without requiring an external power input and with a low power level of the vehicle battery.

Embodiments may use three power sources to charge the supercapacitor module. One is to receive power from an internal rechargeable battery of the start-up power supply. Another is to receive power from an external input. A third source is to receive power from a vehicle battery connected to outputs of the start-up power supply. During use, the start-up power supply may automatically monitor and evaluate the current performance parameters of the three sources and select an optimal source to quickly charge the supercapacitor module.

In accordance with an aspect of the present invention, there is provided a start-up power supply including a battery, a supercapacitor module, and an output configured to be coupled to terminals of a vehicle battery. A switch module couples an output of the supercapacitor module to the output. A charging circuit is coupled between the battery and the supercapacitor module where the charging circuit is further being coupled to the output. A control module is coupled to the charging circuit, the switching module, the battery, and the supercapacitor module. The control module configured to detect a voltage of a supercapacitor module, determine, that the voltage of the supercapacitor module is above a voltage of the battery, and charge the supercapacitor module until the voltage of the supercapacitor module reaches a voltage between a minimum voltage to allow a vehicle to start and a voltage of a full threshold of the supercapacitor module.

In further embodiments, the control module is further configured to determine that the voltage of the supercapacitor module is higher than a pre-charge voltage of the supercapacitor module and connect the battery and the supercapacitor module in parallel thereby enabling the voltage of the supercapacitor module to charge to a voltage of the battery.

In further embodiments, the control module is further configured to determine that the voltage of the supercapacitor module is below a pre-charge voltage of the supercapacitor module, connect through the charging circuit, the battery to the supercapacitor module through the charging circuit, and charge the supercapacitor module until the voltage of the supercapacitor module is higher than the pre-charge voltage of the supercapacitor module.

In accordance with an aspect of the present invention, there is provided a method for providing a start-up power supply. The method including detecting, by a control module of a start-up power supply, a voltage of a supercapacitor module. Also, determining, that the voltage of the supercapacitor module is above a voltage of a battery. Then, direct charging, by a charging circuit, the supercapacitor module until the voltage of the supercapacitor module reaches a voltage of a full threshold of the supercapacitor module.

Embodiments further include determining, by the control module, that the voltage of the supercapacitor module is higher than a pre-charge voltage of the supercapacitor module and connecting the battery and the supercapacitor module in parallel thereby enabling the voltage of the supercapacitor module to charge to a voltage of the battery.

Embodiments further include determining, by the control module, that the voltage of the supercapacitor module is below a pre-charge voltage of the supercapacitor module. Also, connecting through the charging circuit, the battery to the supercapacitor module through the charging circuit. Then charging, the supercapacitor module until the voltage of the supercapacitor module is higher than the pre-charge voltage of the supercapacitor module.

Embodiments have been described above in conjunctions with aspects of the present invention upon which they can be implemented. Those skilled in the art will appreciate that embodiments may be implemented in conjunction with the aspect with which they are described but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE FIGURES

Further features and advantages of the present invention will become apparent from the following detailed description, taken in combination with the appended drawings, in which:

FIG. 1 illustrates a block diagram of a start-up power supply, according to an embodiment.

FIG. 2 illustrates a charging circuit that may be used in a start-up power supply, according to an embodiment.

FIG. 3 illustrates a parallel charging & discharging circuit that may be used in a start-up power supply, according to an embodiment.

FIG. 4 illustrates switching modules included in a start-up power supply, according to an embodiment.

FIG. 5 illustrates an alternate block diagram of a parallel charging and discharging circuit, according to an embodiment.

FIG. 6 illustrates a method for charging a supercapacitor module when the voltage of the supercapacitor module is below a pre-charge voltage of the supercapacitor module, according to an embodiment.

FIG. 7 illustrates a method for charging a supercapacitor module when the voltage of the supercapacitor module is higher than a pre-charge voltage of the supercapacitor module, according to an embodiment.

FIG. 8 illustrates a method for charging a supercapacitor module when the voltage of the supercapacitor module is above a voltage of a battery, according to an embodiment.

FIG. 9 illustrates an electronic device that may be incorporated into a start-up power supply, according to an embodiment.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs.

Embodiments of the present invention provide a start-up power supply including a battery, a supercapacitor module, and an output configured to be coupled to terminals of a vehicle battery. A switch module couples an output of the supercapacitor module to the output. A charging circuit is coupled between the battery and the supercapacitor module where the charging circuit may also be coupled to the output. A control module is coupled to the charging circuit, the switching module, the battery, and the supercapacitor module. The control module may be configured to detect a voltage of a supercapacitor module, determine that the voltage of the supercapacitor module is above a voltage of the battery, and charge the supercapacitor module until the voltage of the supercapacitor module reaches a voltage between a minimum voltage to allow a vehicle to start and a voltage of a full threshold of the supercapacitor module.

In further embodiments, the control module is further configured to determine that the voltage of the supercapacitor module is higher than a pre-charge voltage of the supercapacitor module and connect the battery and the supercapacitor module in parallel thereby enabling the voltage of the supercapacitor module to charge to a voltage of the battery.

In further embodiments, the control module is further configured to determine that the voltage of the supercapacitor module is below a pre-charge voltage of the supercapacitor module, connect through the charging circuit, the battery to the supercapacitor module through the charging circuit, and charge the supercapacitor module until the voltage of the supercapacitor module is higher than the pre-charge voltage of the supercapacitor module.

In further embodiments, the battery may be a rechargeable battery.

Embodiments further include an input port that may be configured to receive an input voltage with the charging circuit being coupled to the input.

In further embodiments, the supercapacitor module may include an electrostatic double-layer capacitor.

Embodiments may further include a discharging circuit coupled between the battery and the supercapacitor module, the discharging circuit further being coupled to the output.

In further embodiments, the charging circuit may include a boost circuit or a step-down circuit.

In further embodiments, the charging circuit may include a parallel charging circuit.

In further embodiments, the supercapacitor module may include a plurality of supercapacitors connected in series, connected in parallel, or connected in both series and in parallel to meet voltage and current specifications.

In further embodiments, the supercapacitor module includes an equalization unit configured to prevent excessive voltages within the supercapacitor module.

In further embodiments, the switch module couples the output of the supercapacitor module to a positive terminal of the output.

In further embodiments, the switch module includes a switching relay.

In further embodiments, the switch module includes a switching FET.

Embodiments of the present invention provide a method for providing a start-up power supply. The method including detecting, by a control module of a start-up power supply, a voltage of a supercapacitor module. Also, determining, that the voltage of the supercapacitor module is above a voltage of a battery. Then, direct charging, by a charging circuit, the supercapacitor module until the voltage of the supercapacitor module reaches a voltage of a full threshold of the supercapacitor module.

Embodiments further include determining, by the control module, that the voltage of the supercapacitor module is higher than a pre-charge voltage of the supercapacitor module, and connecting the battery and the supercapacitor module in parallel thereby enabling the voltage of the supercapacitor module to charge to a voltage of the battery.

Embodiments further include determining, by the control module, that the voltage of the supercapacitor module is below a pre-charge voltage of the supercapacitor module. Also, connecting through the charging circuit, the battery to the supercapacitor module through the charging circuit. Then charging, the supercapacitor module until the voltage of the supercapacitor module is higher than the pre-charge voltage of the supercapacitor module.

In further embodiments, the battery includes an internal rechargeable battery of the start-up power supply.

In further embodiments, the battery includes an external voltage received from an input port of the start-up power supply or from a vehicle battery coupled to output terminals of the start-up power supply.

Embodiments further include discharging the battery and the supercapacitor module to output terminals of the start-up power supply where the discharging is performed while the battery and the supercapacitor module are connected in parallel.

In further embodiments, the output terminals are coupled to terminals of a vehicle battery.

Supercapacitor 102 may include one or more individual supercapacitors, for example supercapacitor 102a and supercapacitor 102b. As illustrated, supercapacitors 102a and 102b may be connected in series to increase the voltage of the supercapacitor module 102, or they may be connected in parallel, increasing the current that may pass through the supercapacitor module 102. Individual supercapacitors may be arranged and connected in both parallel and series simultaneously to produce a supercapacitor module 102 with specifications required to provide a boost to a vehicle battery and be sufficient to start the vehicle. In embodiments an electrostatic double-layer capacitor type supercapacitor may be used. Electrostatic double-layer capacitors have the favourable characteristics of having high power density (i.e., small volume and large capacity), good low-temperature characteristics (small capacity attenuation), and high instantaneous discharge current that may be used to for boosting a vehicle battery to start a vehicle.

Battery 104 is typically an internal battery that may preferably be rechargeable. As used herein a battery may be used to refer to a power source that may be used to charge supercapacitor module 102. This battery may be internal battery 104, an external battery connected to and applying a voltage to input port 110, or a vehicle battery 130 connected through terminals to an output of start-up power supply 100. In embodiments the internal battery 104 may have a similar output voltage to vehicle battery 130. Similarly, input port 110 may be specified and configured for input voltages similar to vehicle battery. Circuitry to detect the presence of a voltage applied at input port 110 may require that the input voltage be in a range similar to a vehicle battery to be considered a valid input. Input port 110 may also be configured to limit the voltage and current at input port 110 to prevent over voltage or over current situations.

The invention will now be described with reference to specific examples. It will be understood that the following examples are intended to describe embodiments of the invention and are not intended to limit the invention in any way.

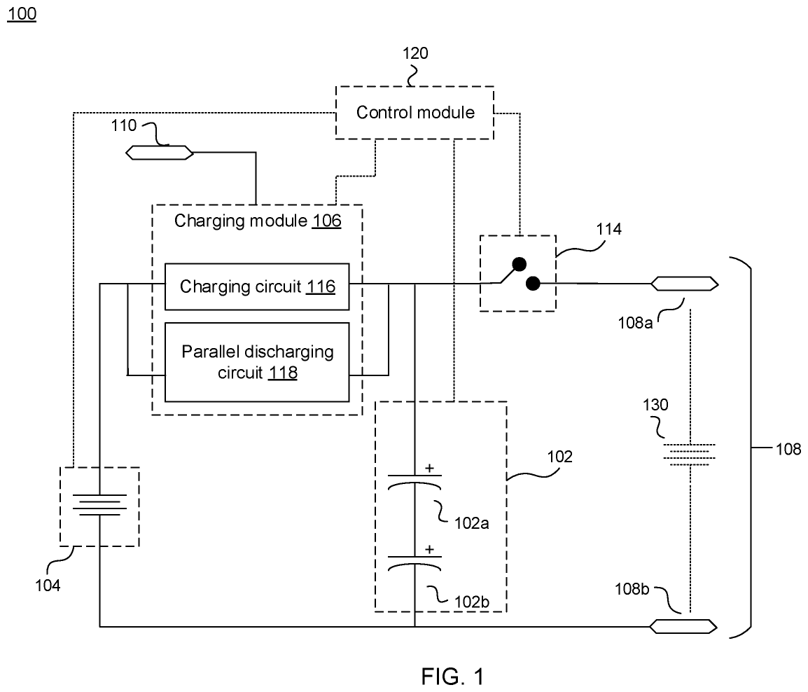

Referring to FIG. 1, embodiments include a start-up power supply incorporating the characteristics of high power density, good low temperature characteristics and high instantaneous discharge current of the supercapacitor module 102 to allow a vehicle to quickly start, even at low temperatures. Embodiments may include an internal battery 104, that may be a rechargeable battery, so that the start-up power supply 100 may be used to quickly start a vehicle even without use of an external power input and when the vehicle battery has a very low power. The supercapacitor module 102 may be charged and discharged quickly to enable the vehicle to start quickly.

Embodiments include a start-up power supply 100 that may provide emergency power to start a vehicle at low temperatures such as −40° C. or −55° C. The start-up power supply 100 includes a battery 104, a charging module 106, a supercapacitor module 102, a switch module 114, and a control module 120. The control module 120 is electrically connected with the battery 104, the charging module 106, the supercapacitor module 102, and the switch module 114.

The charging module 106 may include a charging circuit 116 and a parallel discharging circuit 118, and is electrically connected between the battery 104 and the supercapacitor module 102. In embodiments, a charging circuit may be a boost circuit, a step-down circuit, or a parallel charging circuit.

In embodiments, the parallel discharging circuit may couple the battery 104 and the supercapacitor module 102 in parallel to provide a high current to a vehicle battery 130 to enable the vehicle to start. Anti-backflow diodes may be connected in series between the battery 104 and the supercapacitor module 102 to prevent supercapacitor current from flowing towards the battery 104.

In order to meet voltage and current requirements of the start-up power supply 100, the supercapacitor module 102 may include one or more supercapacitor connected in series, connected in parallel, or connected in both series and in parallel. For example, connecting two supercapacitors, such as supercapacitor 102a and supercapacitor 102b, in series increases the voltages of the supercapacitor module 102. Connecting two supercapacitors in parallel will increase the current capacity of the supercapacitor module 102. The supercapacitor module 102 may also include an equalization unit which may be used for voltage equalization management of the supercapacitors so as to prevent one or more of the supercapacitors in the supercapacitor module 102 from being damaged due to excessive voltage.

In embodiments, switch module 114, or other switches in the start-up power supply 100, can be implemented using one or more relays or field effect transistors (FETs), etc. Switch module 114 as illustrated in FIG. 1 is used to electrically connect a positive terminal of supercapacitor module 102 to a positive output 108a of terminals 108. Positive output 108a and negative output 108b may be connected to a vehicle battery 130 to provide high-current energy for the car battery to start the vehicle.

In embodiments, an input port 110 may be used to provide an external power supply to charge supercapacitor module 102 or internal battery 104 in the case where it is rechargeable. Charging of internal battery 104, if rechargeable, and supercapacitor module 102 may be done using a power supply applied at input port 110.

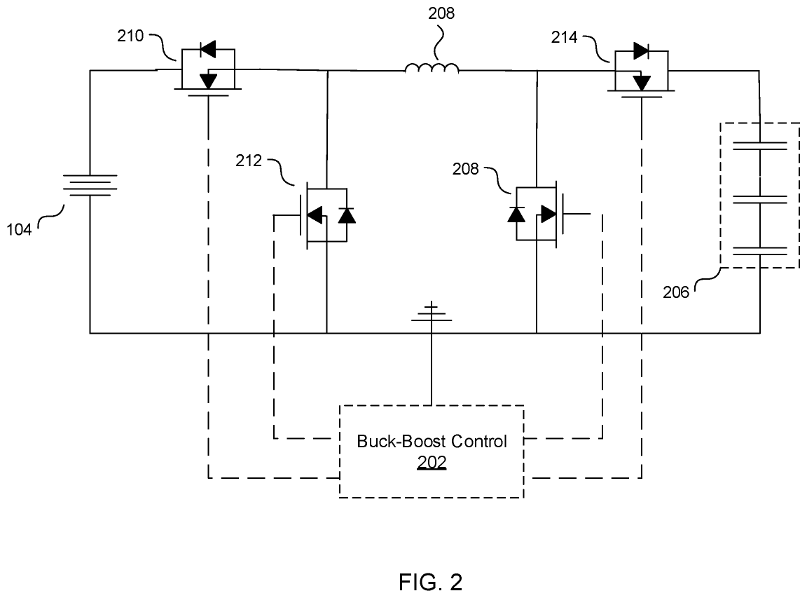

FIG. 2 illustrates a charging circuit 116 that may be used in a start-up power supply, according to an embodiment. Though different variants of the illustrated circuit may be used, the charging circuit illustrated is an example of a buck-boost circuit that may be included in the charging circuit 116 used to implement the charging function. FET 210 connects a positive end of battery 104 to one end of inductor 208. FET 212 connects a positive end of battery 104 to ground. FET 214 connects a positive end of supercapacitor module 206 to the other end of inductor 208. FET 208 connects a positive end of supercapacitor module 206 to ground. Buck-boost control 202 may control the four FETs to boost the voltage supplied by battery 104 to charge supercapacitor module 206 to a voltage up to V1 602 or to V3 608.

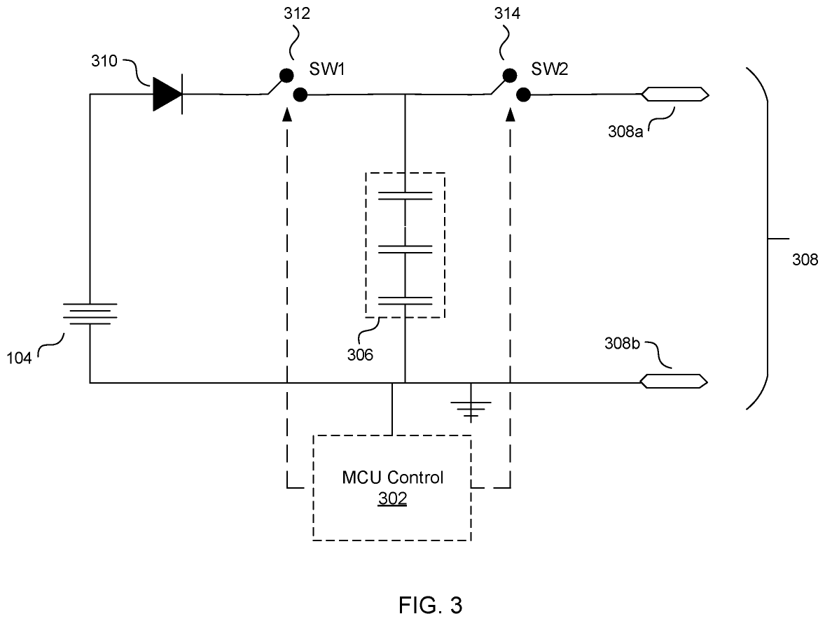

FIG. 3 illustrates a parallel discharging circuit 118 that may be used in a start-up power supply, according to an embodiment. Positive ends of battery 104 and supercapacitor module 306 may be connected in parallel through diode 310 and switch SW1 312, where diode 310 prevents current from supercapacitor module 306 from flowing back towards battery 104. Under control of MCU control 302, when SW1 312 is closed and SW2 314 is opened, a charging circuit is formed and the battery 104 charges the supercapacitor module 306 in parallel. When both SW1 312 and SW2 314 are closed, a parallel discharge circuit is formed, and the battery 104 and supercapacitor module 306 are discharged in parallel through output 308.

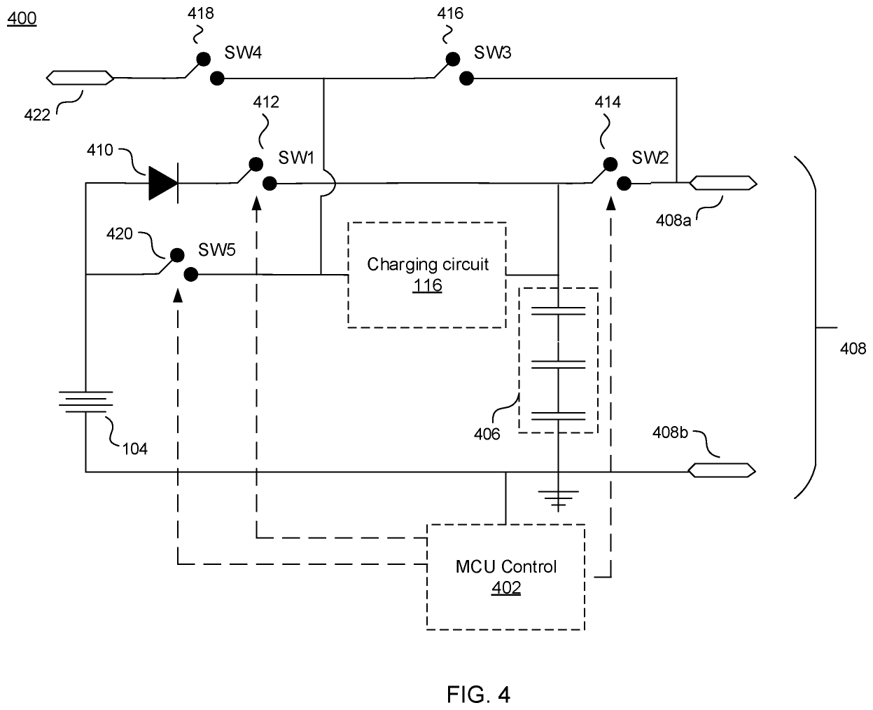

FIG. 4 illustrates switching modules included in a start-up power supply 400, according to an embodiment. Charging of supercapacitor module 406 can be done using different power sources using methods under control of MCU control 402. In particular, supercapacitor module 406 may be charged from internal battery 104, with an external vehicle battery, or with an external DC input. When SW5 420 is closed, the internal battery 104 may charge the supercapacitor module 406 through charging circuit 116. When SW3 416 is closed and SW5 420 is opened, an external vehicle battery at the output port 408 may charge the supercapacitor module 406 through charging circuit 116. When SW4 418 is closed and SW5 420 is opened, the external DC input received through input port 422 may charge the supercapacitor module through the charging circuit 116. Further configurations are that SW2 414, SW3 416, SW4 418, and SW5 420 may all be opened and SW1 412 may be closed to allow the internal battery 104 to charge the supercapacitor module 406 in parallel. Also, SW1 412, SW3 416, SW4 418, and SW5 420 may all be opened and SW2 414 may be closed, thereby allowing an external car battery to charge the supercapacitor module 406 in parallel. Finally, in order to discharge the battery 104 and supercapacitor module 406 in parallel to boost a vehicle battery connected to output 408 (outputs 408a and 408b), SW3 416, SW4 418, and SW5 420 may all be opened while SW1 412 and SW2 414 are closed.

As will be understood by those of skill in the art, other arrangements and circuit arrangements may be implemented that allow for the use of multiple power sources to charge supercapacitor module 406. A start-up power supply 400 may automatically monitor and evaluate the current performance parameters of the available power sources to select the optimal and fastest channel to charge the supercapacitor module 406.

The start-up power supply 400 may include an anti-backflow diode 410 between rechargeable battery 104 and the supercapacitor module 406 to prevent the energy or current of the supercapacitor module from flowing into battery 104. When the supercapacitor module 406 and the battery 104 are discharged to boost a vehicle battery through terminals 408, switch module 414 and switch 412 are closed connect the battery 104 and supercapacitor module 406 in parallel allowing the battery 104 to assist supercapacitor module 406 in parallel. In other words, battery 104 and the supercapacitor module 406 may provide current to boost the vehicle battery simultaneously. In this way, the energy is released quickly, which greatly improves the boosting ability of the start-up power supply 400.

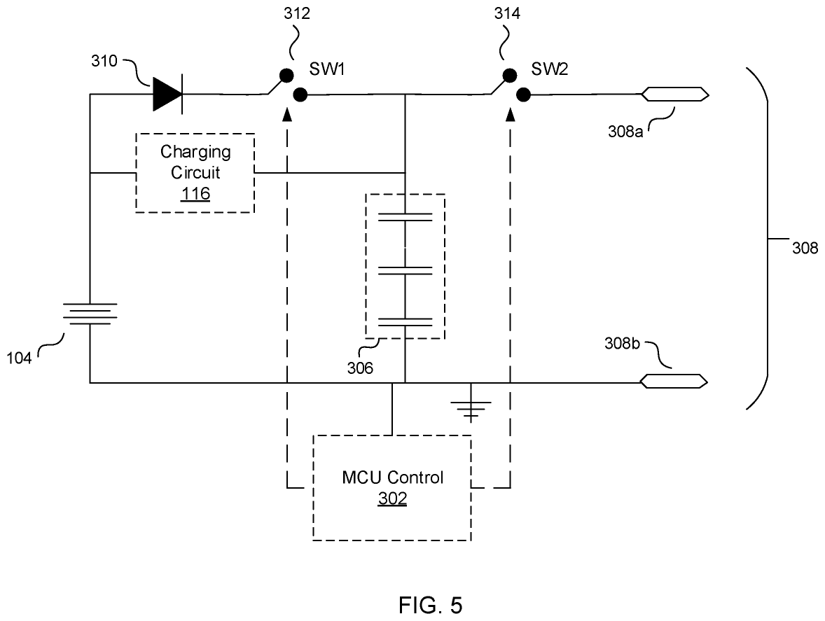

FIG. 5 illustrates an alternate block diagram of the use of a parallel charging and discharging circuit, according to an embodiment. MCU control 302 may be configured to control SW1 312 and SW2 314. When parallel charging, SW1 312 may be closed and SW2 314 may be opened, allowing battery 104 and supercapacitor module 306 to be connected in parallel through charging circuit 116. This configuration allows the battery 104 to rapidly charge the supercapacitor module 306 to the level of the voltage of the battery 104. Diode 310 prevents current from the supercapacitor module 306 flowing back to the battery 104. In order to discharge the battery 104 and the supercapacitor module 306 to boost a vehicle battery, MCU control 302 may close both SW1 312 and SW3 314 to connect both the battery 104 and the supercapacitor module 306 in parallel to rapidly supply current to a vehicle battery connects to outputs 308a and 308b.

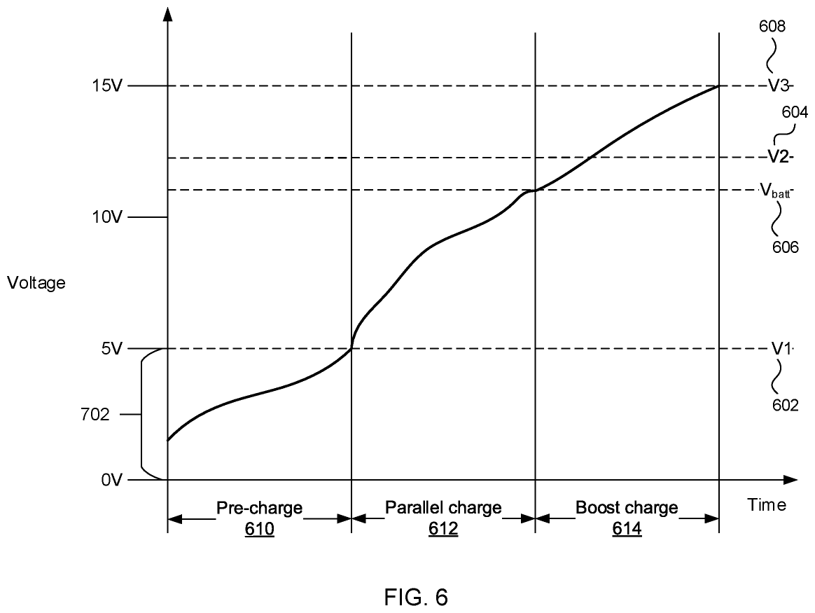

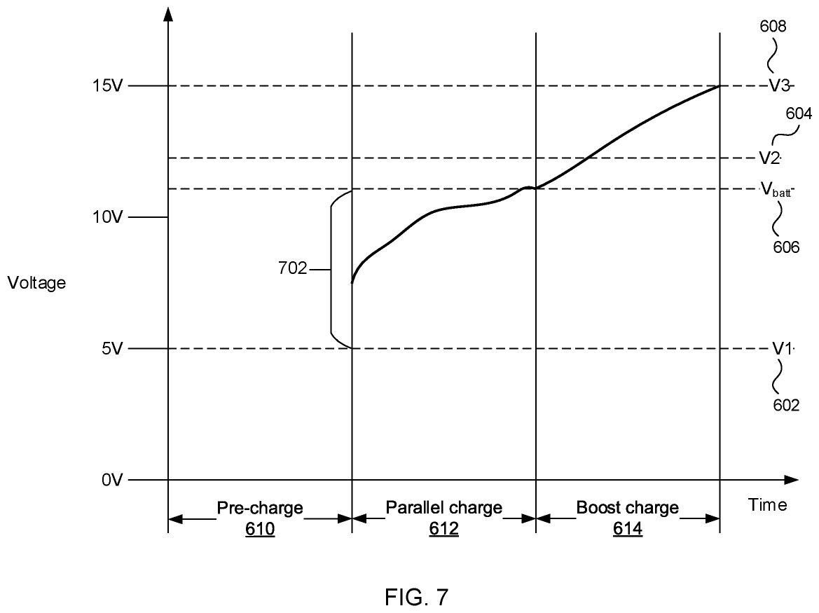

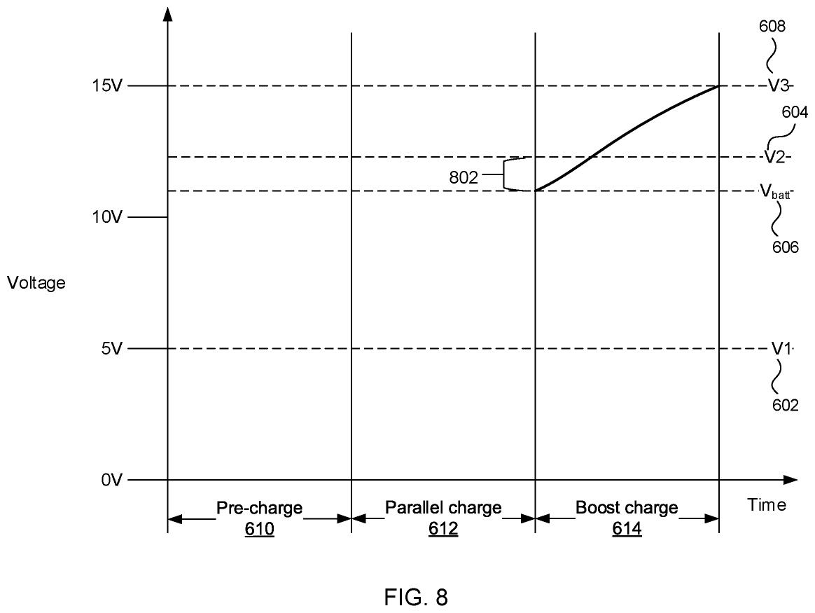

In embodiments, start-up power supply 100 will charge the supercapacitor module 102 to a sufficiently high voltage in order to provide sufficient current to boost a vehicle battery 130 connected to the outputs 108 of the start-up power supply 100 and start the vehicle. After the start-up power supply 100 has been started and initialized, the control module 120 detects the voltage of the supercapacitor module 102. According to the detected voltage across the supercapacitor module 102, different methods may be used for charging the supercapacitor module 102 to prepare and enable it to reliably boost a vehicle battery 130. Note that for describing the embodiments illustrated in FIG. 6, FIG. 7, and FIG. 8, it is assumed that the start-up power supply 100 has selected internal battery 104 as the supercapacitor charging channel. In different embodiments, instead of using internal battery 104, an external battery or power source may be used to supply a voltage to input port 110 to contribute to charging the supercapacitor module 102. Alternatively, a suitably charged external vehicle battery connected to outputs 108 may also contribute to charging the supercapacitor module 102.

FIG. 6 illustrates an embodiment of method 600 for charging a supercapacitor module 102 of a start-up power supply 100 when the voltage of the supercapacitor module is initially below a pre-charge voltage of the supercapacitor module. Supercapacitors may be transported fully discharged and when installed, they will be at 0 V. Also, when in use to boost a vehicle battery 130, they may again be discharged below a pre-charge voltage. Since supercapacitors inherently have a low equivalent series resistance (ESR), at voltages below the pre-charge voltage, a supercapacitor may appear to be a short circuit and while charging supercapacitor module 102 when one or more of its supercapacitors, such as 102a or 102b is below their pre-charge voltage, a charging circuit may need to limit inrush currents. A large inrush current that is not limited may prevent operation of a start-up power supply and cause it to be powered off, especially at low temperatures. Embodiments incorporate pre-charge phase 610 to avoid this limitation.

In method 600, after the start-up power supply 100 has been started and initialized, the control module 120 detects the voltage of the supercapacitor module 102 and finds that it is between 0V and a voltage V1 602, which in this embodiment is the pre-charge voltage of the supercapacitor module 102, below which a charging current may have to be limited. Therefore, charging method 600 starts in a pre-charge phase 610. When the voltage of the supercapacitor is lower than the pre-charge voltage V1 602, the rechargeable battery 104 may be coupled to the supercapacitor module 102 through charging circuit 116 and used to pre-charge the supercapacitor module 102, with the charging circuit 116 limiting the charging current as appropriate to prevent damage to the individual supercapacitors, such as supercapacitors 102a and 102b. In an embodiment, pre-charge voltage V1 602 may be between 0V and approximately 5V, depending on the characteristics of the supercapacitors such as 102a and 102b that are included in supercapacitor module 102. Once the voltage across the supercapacitor module 102 is as high as V1 602, the charging circuit 116 may be closed, or shut off and the method 600 proceeds to the parallel charge phase 612. In the parallel charge phase 612, the battery 104 is connected to the supercapacitor module 102 in parallel through the parallel charging circuit 116 thereby enabling the voltage of the supercapacitor module 102 to quickly charge to at least a voltage of the battery, Vbatt 606. In parallel charge phase 612, instantaneous charging current from the battery to the supercapacitor module 102 may reach hundreds of amperes. It is difficult for charging circuit 116 to meet these requirements and therefore it is not used in this phase. In an embodiment, Vbatt 606 may be approximately 12.8V. Finally in the boost charge phase 614, direct charging may be used to boost the supercapacitor module 102 voltage to a preset value V3 608 through the charging circuit 116. V3 608 is determined as a maximum voltage across supercapacitor module 102 without exceeding maximum voltage limits of the supercapacitors (in other words, the full thresholds of the supercapacitors) within supercapacitor module 102. In an embodiment, preset value V3 608 may be approximately 14.5V.

FIG. 7 illustrates a method 700 for charging a supercapacitor module 100 when the voltage of the supercapacitor module is higher than a pre-charge voltage, V1 602 of the supercapacitor module 102, according to an embodiment. When the voltage of the supercapacitor module 102 is initially higher than the threshold V1 602 and lower than the voltage of the rechargeable battery, Vbatt 606, the rechargeable battery may charge the supercapacitor module 102 using the parallel charge phase 612. The battery 104 is connected to the supercapacitor module 102 in parallel through the parallel charging circuit 116 thereby enabling the voltage of the supercapacitor module 102 to charge to at least a voltage of the battery, Vbatt 606. In an embodiment, Vbatt 606 may be approximately 12.8V. Finally in the boost charge phase 614, direct charging may be used to boost the supercapacitor module 102 voltage to a preset value V3 608 through the charging circuit 116. V3 608 is determined as a maximum voltage across supercapacitor module 102 without exceeding maximum voltages of the supercapacitors (in other words, the full thresholds of the supercapacitors) within supercapacitor module 102. In an embodiment, preset value V3 608 may be approximately 14.5V.

FIG. 8 illustrates a method 800 for charging a supercapacitor module when the voltage of the supercapacitor module is above a voltage of a battery, Vbatt 606, according to an embodiment. In the boost charge phase 614, direct charging may be used to boost the supercapacitor module 102 voltage to a preset value V3 608 through the charging circuit 116. V3 608 is determined as a maximum voltage across supercapacitor module 102 without exceeding maximum voltages of the supercapacitors (in other words, the full thresholds of the supercapacitors) within supercapacitor module 102. In an embodiment, preset value V3 608 may be approximately 14.5V.

Alternatively, in embodiments, direct charging may be used to boost the supercapacitor module 102 voltage to a preset value between V2 604 and V3 608 through the charging circuit 116. When the supercapacitor voltage is higher than the threshold V2 604, the rechargeable battery and the external power supply will no longer charge the supercapacitor, and the vehicle can be started directly at this time. V2 voltage 604 refers to a minimum voltage that allows a vehicle to start. In other words, if the voltage of the supercapacitor module 102 is greater than V2 604, the supercapacitor module 604 can start the vehicle without further charging. However, when the voltage of the supercapacitor module 102 is less than V2 604, the supercapacitor module 102 needs to be further charged to V2 604 before it can be used to start the vehicle. V2 604 is used as a basis for judging whether the supercapacitor module 102 needs to be recharged and is not required to play a role in the three-stage recharging of supercapacitor module 102 as illustrated in FIG. 6, FIG. 7, and in FIG. 8.

As illustrated in FIG. 6, FIG. 7, and FIG. 8, V1<Vbatt<V2<V3. However, in embodiments, V2 604 may be less than Vbatt 606. In these embodiments, parallel charge phase may be used to charge the supercapacitor module 102 to a voltage, V2 604, sufficient to boost vehicle battery 130. However, for improved performance, boost charge phase 614 may be used to boost the voltage of the supercapacitor module 102 to V3 608.

In the above cases illustrated in FIG. 6, FIG. 7, and FIG. 8, when the voltage of the supercapacitor module 102 is higher than the threshold V2 604 or charged to the preset value V3 608, and the positive output 108a and the negative output 108b are correctly connected to the car battery, current from the rechargeable battery passes through the parallel discharge circuit and is combined with current from the supercapacitor module 102.

Therefore, the switch module 114 can increase the high-current starting energy applied to vehicle battery and facilitate the vehicle starting. Since the supercapacitor module 102 is able to provide instantaneous parallel direct charging, the charging time of the supercapacitor is greatly reduced, and the rechargeable battery and the supercapacitor together provide the starting energy for the car battery during discharge, and the starting ability is greatly improved. This provides the benefit of starting the vehicle quickly and successfully at one time.

In embodiments, the start-up power supply 100 may utilize a vehicle battery 130 or an external power source coupled to the charging circuit 116 to provide much of the functions of internal battery 104. Similarly, the system may be set for or select an external vehicle battery connected through terminals 108 as the charging source for the supercapacitor module 102. In this case the process of charging the supercapacitor module 102 may be the same as when internal battery 104 is used, as illustrated in FIG. 6, FIG. 7, and FIG. 8. In other words, the three phases; pre-charging 610, parallel charging 612, and boost charging 614 may be used to charge the supercapacitor module 102 to a voltage V3 608 or between voltage V2 604 and voltage V3 608. When in use, a charged vehicle battery may be connected to terminals 108 and used by the start-up power supply 100 to charge the supercapacitor module 102. Then the terminals may be attached to a discharged vehicle battery 130 and used to boost the vehicle using the same discharge process. When boosting a vehicle battery 130, the rechargeable battery 104 and supercapacitor module 102 may both be selected to provide starting energy for the car battery and improve the starting ability of the start-up power supply 100.

In embodiments when the start-up power supply 100 selects or is configured to use the external input 110 as the supercapacitor charging channel, the external power source may be used to charge the supercapacitor module 102 using the three phases; pre-charging 610, parallel charging 612, and boost charging 614 as described, to charge the supercapacitor module 102 to a voltage V3 608 or between voltage V2 604 and voltage V3 608 . . . . Alternatively, the start-up power supply 100 may be used by the start-up power supply 100 to directly boost the voltage of the supercapacitor module 102 to V3 608 or between voltage V2 604 and voltage V3 608 through the charging circuit using only the boost charge phase 614, without use of the pre-charging 610 or parallel charging 612 phases.

In embodiments, a user may configure the start-up power supply 100 to use an internal battery, a vehicle battery connected through terminals 108, or an external power source connected to input port 110 to charge supercapacitor module 102. In other embodiments, start-up power supply 100 may detect any or all of the three possible sources and select the best power sources based on the presence of each source and suitable characteristics of each source. Characteristics of the power sources may include the state of the internal battery 104 and the state of the vehicle battery 130, or a second vehicle battery used for charging the supercapacitor module 102.

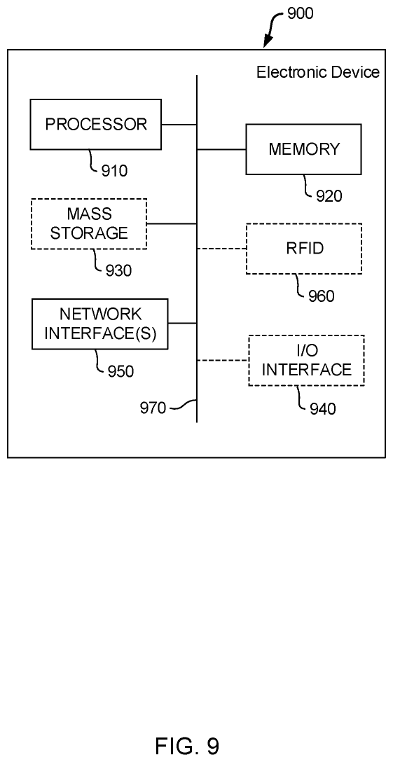

FIG. 9 illustrates an electronic device that may be incorporated within a start-up power supply 100, according to an embodiment, and may perform any or all of operations of the above methods and features explicitly or implicitly described herein, according to different aspects of the present disclosure. For example, parts of control module 120, buck-boost control 202, MCU control 302, MCU control 402 may be implemented using an electronic device 900 in the form of a microprocessor, a microcontroller, an ASIC, or programmable logic such as an FPGA, etc. Furthermore, components of start-up power supply 100, such as battery 104, supercapacitor module 102, charging module 106, etc., may incorporate an electronic device, such as a small microcontroller to monitor or control the component.

As shown, electronic device 900, an apparatus, may include a processor 910, such as a Central Processing Unit (CPU) or specialized processors such as a Graphics Processing Unit

(GPU) or other such processor unit, memory 920, non-transitory mass storage 930, input-output (I/O) interface 940, network interface 950, all of which may be communicatively coupled via bi-directional bus 970. According to certain aspects, any or all of the depicted elements may be utilized, or only a subset of the elements. Furthermore, apparatus 900 may contain multiple instances of certain elements, such as multiple processors, memories, network interfaces, or I/O interfaces. I/O interface 940 may be connected or coupled to elements such as keypads, push buttons, LED lights, LCD displays to provide a user interface of the start-up power supply 100. Network interface 950 may provide access through Bluetooth, WiFi, or similar technology to connect to external devices such as cell phones, tablets, laptop computers, desktop computers, etc. to provide alternative methods of monitoring or controlling the start-up power supply 100 and its operation. Also, elements of the hardware device may be directly coupled to other elements without the bi-directional bus 970. Additionally, or alternatively to a processor and memory, other electronics, or processing electronics, such as integrated circuits, application specific integrated circuits, field programmable gate arrays, digital circuitry, analog circuitry, chips, dies, multichip modules, substrates or the like, or a combination thereof may be employed for performing the required logical operations.

Memory 920 may include any type of non-transitory memory such as static random-access memory (SRAM), dynamic random-access memory (DRAM), synchronous DRAM (SDRAM), read-only memory (ROM), any combination of such, or the like. The mass storage element 930 may include any type of non-transitory storage device, such as a solid-state drive, hard disk drive, flash memory, ROM, EEPROM, USB drive, or any computer program product configured to store data and machine executable program code. According to certain aspects, memory 920 or mass storage 930 may have recorded thereon statements and instructions executable by processor 910 for performing any method operations described herein.

The processor 910 and memory 920 may function together as a chipset which may be provided together for installation into start-up power supply 100 in order to implement the methods of providing a start-up power supply. Actions associated with methods described herein can be implemented as coded instructions in a computer program product. In other words, the computer program product is a computer-readable medium upon which software code or instructions is recorded to execute the method when the computer program product is loaded into memory and executed on a processor of a computing device.

Further, each operation of the method may be executed on any real or virtual computing device, such as a personal computer, server, tablet, smartphone, or the like and pursuant to one or more, or a part of one or more, program elements, modules or objects generated from any programming language, such as C++, Java, or the like. In addition, each operation, or a file or object or the like implementing each said operation, may be executed by special purpose hardware or a circuit module designed for that purpose.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

What is claimed is:

1. A start-up power supply comprising:
a battery;
a supercapacitor module;
an output configured to be coupled to terminals of a vehicle battery;
a switch module coupling an output of the supercapacitor module to the output;
a charging circuit coupled between the battery and the supercapacitor module, the charging circuit further being coupled to the output; and
a control module coupled to the charging circuit, the switching module, the battery, and the supercapacitor module, the control module configured to:
detect a voltage of a supercapacitor module;
determine, that the voltage of the supercapacitor module is above a voltage of the battery; and
charge the supercapacitor module until the voltage of the supercapacitor module reaches a voltage between a minimum voltage to allow a vehicle to start and a voltage of a full threshold of the supercapacitor module.

2. The start-up power supply of claim 1, wherein the control module is further configured to:
determine that the voltage of the supercapacitor module is higher than a pre-charge voltage of the supercapacitor module; and
connect the battery and the supercapacitor module in parallel thereby enabling the voltage of the supercapacitor module to charge to a voltage of the battery.

3. The start-up power supply of claim 1, wherein the control module is further configured to:
determine that the voltage of the supercapacitor module is below a pre-charge voltage of the supercapacitor module;
connect through the charging circuit, the battery to the supercapacitor module through the charging circuit; and
charge the supercapacitor module until the voltage of the supercapacitor module is higher than the pre-charge voltage of the supercapacitor module.

4. The start-up power supply of claim 1, wherein the battery is a rechargeable battery.

5. The start-up power supply of claim 1, further comprising an input port configured to receive an input voltage, the charging circuit being coupled to the input.

6. The start-up power supply of claim 1, wherein the supercapacitor module includes an electrostatic double-layer capacitor.

7. The start-up power supply of claim 1, further comprising a discharging circuit coupled between the battery and the supercapacitor module, the discharging circuit further being coupled to the output.

8. The start-up power supply of claim 1, wherein the charging circuit includes a boost circuit, a step-down circuit or a parallel charging circuit.

9. The start-up power supply of claim 1, wherein the supercapacitor module includes a plurality of supercapacitors connected in series.

10. The start-up power supply of claim 1, wherein the supercapacitor module includes a plurality of supercapacitors connected in parallel.

11. The start-up power supply of claim 1, wherein the supercapacitor module includes an equalization unit configured to prevent excessive voltages within the supercapacitor module.

12. The start-up power supply of claim 1, wherein the switch module couples the output of the supercapacitor module to a positive terminal of the output.

13. The start-up power supply of claim 1, wherein the switch module includes a switching relay.

14. The start-up power supply of claim 1, wherein the switch module includes a switching FET.

15. A method for providing a start-up power supply comprising:
detecting, by a control module of a start-up power supply, a voltage of a supercapacitor module;
determining, that the voltage of the supercapacitor module is above a voltage of a battery;
direct charging, by a charging circuit, the supercapacitor module until the voltage of the supercapacitor module reaches a voltage between a minimum voltage to allow a vehicle to start and a voltage of a full threshold of the supercapacitor module.

16. The method of claim 15, further comprising:
determining, by the control module, that the voltage of the supercapacitor module is higher than a pre-charge voltage of the supercapacitor module;
connecting the battery and the supercapacitor module in parallel thereby enabling the voltage of the supercapacitor module to charge to a voltage of the battery.

17. The method of claim 15, further comprising:
determining, by the control module, that the voltage of the supercapacitor module is below a pre-charge voltage of the supercapacitor module;
connecting through the charging circuit, the battery to the supercapacitor module through the charging circuit; and
charging, the supercapacitor module until the voltage of the supercapacitor module is higher than the pre-charge voltage of the supercapacitor module.

18. The method of claim 15, wherein the battery includes an internal rechargeable battery of the start-up power supply.

19. The method of claim 15, wherein the battery includes an external voltage received from an input port of the start-up power supply or a vehicle battery coupled to output terminals of the start-up power supply.

20. The method of claim 19 further comprising:
discharging the battery and the supercapacitor module to output terminals of the start-up power supply, the discharging being performed while the battery and the supercapacitor module are connected in parallel.
